(19) United States
(12) Patent Application Publication
(10) Pub. No.: US 2014/0064112 A1
(43) Pub. Date: Mar. 6, 2014

(54) CONTEXT-BASED POSITION DETERMINATION

(71) Applicants: Saumitra Mohan Das, San Jose, CA (US); Ayman Fawzy Naguib, Cupertino, CA (US)

(72) Inventors: Saumitra Mohan Das, San Jose, CA (US); Ayman Fawzy Naguib, Cupertino, CA (US)

(73) Assignee: QUALCOMM Incorporated, San Diego, CA (US)

(21) Appl. No.: 13/605,853

(22) Filed: Sep. 6, 2012

(51) Int. Cl. H04W 24/00

(52) U.S. Cl. 370/252

(57) ABSTRACT

Disclosed is a method for position determination, including obtaining measurements of at least one characteristic of one or more wireless signals acquired at a mobile station, obtaining a classification of a context of a user co-located with the mobile station, and affecting application of a representation of the signal environment to the measurements for obtaining a position fix based, at least in part, on the classification of the context.

### BACKGROUND

1. Field

The subject matter disclosed herein relates to wireless communication systems, and more specifically, to position determination methods and apparatuses for use with and/or by wireless mobile stations.

2. Information

GPS and other like satellite positioning systems have enabled navigation services for mobile handsets in outdoor environments. Since satellite signals may not be reliably received or acquired in an indoor environment, different techniques may be employed to enable navigation services. For example, mobile stations may obtain a position fix by measuring ranges to three or more terrestrial wireless access points that are positioned at known locations. Such ranges may be measured, for example, by obtaining a MAC ID address from signals received from such access points and obtaining range measurements to the access points by measuring one or more characteristics of signals received from such access points such as, for example, signal strength and round trip delay.

A navigation system may provide navigation assistance or mapped features to a mobile station as it enters a particular area. For example, in some implementations, an indoor navigation system may selectively provide assistance information to mobile stations to facilitate and/or enable location services. Such assistance information may include, for example, information to facilitate measurements of ranges to wireless access points at known fixed locations. For example, “heatmap” data indicating expected received-signal-strength-indicator (RSSI) or round-trip time (RTT) values associated with access points may enable a mobile station to associate signal measurements with locations in an area such as an indoor location or other location. By matching measured RSSI or RTT values of acquired signals marked with particular MAC IDs with the RSSI or RTT values expected for signals marked by these particular MAC IDs at a specific location, the location of the receiver may be inferred to be at the specific location.

### BRIEF DESCRIPTION OF THE FIGURES

Non-limiting and non-exhaustive features will be described with reference to the following figures, wherein like reference numerals refer to like parts throughout the various figures.

FIG. 1 is a system diagram illustrating certain features of a system containing a mobile station, in accordance with an implementation.

FIG. 2 is a schematic block diagram of a process to generate a radio heatmap and to determine a position of a mobile station, according to an implementation.

FIG. 3 is a map of a floor of a building sans cubicles, according to an implementation.

FIG. 4 is a map of a floor of a building showing cubicles, according to an implementation.

FIG. 5 is a flow diagram illustrating a process for obtaining a position fix of a mobile station, according to an implementation.

FIG. 6 is a flow diagram illustrating a process for modifying a radio heatmap, according to an implementation.

FIG. 7 is a schematic block diagram illustrating an exemplary mobile station, in accordance with an implementation.

FIG. 8 is a schematic block diagram of an example computing platform.

### SUMMARY

In some implementations, a method may comprise: obtaining measurements of at least one characteristic of one or more wireless signals acquired at a mobile station; obtaining information for classifying a context of a user co-located with the mobile station; and affecting application of a representation of a signal environment in which the wireless signals were acquired to the measurements for obtaining a position fix based, at least in part, on a classification of the context.

In other implementations, an apparatus may comprise: means for obtaining measurements of at least one characteristic of one or more wireless signals acquired at a mobile station; means for obtaining information for classifying a context of a user co-located with the mobile station; and means for affecting application of a representation of a signal environment in which the wireless signals were acquired to the measurements for obtaining a position fix based, at least in part, on a classification of the context.

In still other implementations, an apparatus may comprise: a transceiver to obtain measurements of at least one characteristic of one or more wireless signals acquired at a mobile station; and one or more processing units to obtain information to classify a context of a user co-located with the mobile station, and to affect application of a representation of a signal environment in which the wireless signals were acquired to the measurements for obtaining a position fix based, at least in part, on a classification of the context.

In other implementations, an article may comprise: a non-transitory storage medium comprising machine-readable instructions stored thereon that are executable by a special purpose computing device to: obtain measurements of at least one characteristic of one or more wireless signals acquired at a mobile station; obtain information to classify a context of a user co-located with the mobile station; and affect application of a representation of a signal environment in which the wireless signals were acquired to the measurements for obtaining a position fix based, at least in part, on a classification of the context.

In yet other implementations, a method may comprise: obtaining measurements of at least one characteristic of one or more wireless signals acquired at a mobile station; determining a representation of a signal environment in which the wireless signals were acquired based, at least in part, on a detected context of the mobile station; estimating a location of the mobile station based, at least in part, on a match of the obtained measurements with the determined representation; and selecting one representation of the signal environment among a plurality of stored representations of the signal environment based, at least in part, on the detected context.

In other implementations, an apparatus may comprise: means for maintaining a database of expected signal characteristics associated with locations in an area; means for obtaining measurements of at least one characteristic of one or more wireless signals acquired at a mobile station; means for modifying the expected signal characteristics based, at least in part, on a detected context of the mobile station; and means for estimating a location of the mobile station based, at least in part, on a match of the obtained measurements with the modified expected signal characteristics.

In other implementations, an apparatus may comprise: a transceiver to obtain measurements of at least one characteristic of one or more wireless signals acquired at a mobile station; and one or more processing units to: maintain a database of expected signal characteristics associated with locations in an area; modify the expected signal characteristics based, at least in part, on a detected context of the mobile station; and estimate a location of the mobile station based, at least in part, on a match of the obtained measurements with the modified expected signal characteristics.

In still other implementations, an article may comprise: a non-transitory storage medium comprising machine-readable instructions stored thereon that are executable by a special purpose computing device to: maintain a database of expected signal characteristics associated with locations in an area; obtain measurements of at least one characteristic of one or more wireless signals acquired at a mobile station; modify the expected signal characteristics based, at least in part, on a detected context of the mobile station; and estimate a location of the mobile station based, at least in part, on a match of the obtained measurements with the modified expected signal characteristics.

### DETAILED DESCRIPTION

Reference throughout this specification to “one example”, “one feature”, “an example” or “one feature” means that a particular feature, structure, or characteristic described in connection with the feature and/or example is included in at least one feature and/or example of the described subject matter. Thus, the appearances of the phrase “in one example”, “an example”, “in one feature”, or “a feature” in various places throughout this specification are not necessarily all referring to the same feature and/or example. Furthermore, the particular features, structures, or characteristics may be combined in one or more examples and/or features, and/or may be omitted from one or more embodiments and/or implementations, and are not limiting to the scope of the claims or the scope of this disclosure.

As used herein, a mobile station (MS) refers to a device such as a cellular or other wireless communication device, personal communication system (PCS) device, personal navigation device, Personal Information Manager (PIM), Personal Digital Assistant (PDA), laptop or other suitable mobile station which is capable of receiving wireless communications. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile station.”

In some implementations, an indoor navigation system may selectively provide assistance information to an MS to facilitate and/or enable location services. Such assistance information may include, for example, information to facilitate measurements of ranges to wireless access points at known fixed locations. For example, “heatmap” data indicating expected received-signal-strength-indicator (RSSI) values or round-trip times (RTT) associated with access points may enable an MS to associate signal measurements with locations in an indoor area. Additionally, such assistance data may also include routeability information indicative of feasible/navigable paths in an indoor area covered by a digital map.

In a particular implementation, assistance information may be provided to an MS from a local server through wireless communication links. The MS may then locally store received assistance information in a local memory. It should be understood, however, that in larger indoor areas with multiple access points and feasible routes, such assistance information may be quite voluminous so as to tax available bandwidth in wireless communication links and data storage space on mobile stations.

According to an embodiment, assistance information may be provided to an MS in a compressed format. For example, such assistance information may be provided as metadata along with metadata included in a digital map. Here, grid points, for example, may be laid over locations in an indoor interval at uniform spacing (e.g., two-feet separation of neighboring grid points). Grid points may comprise a set of discrete points obtained by superimposing uniformly-spaced points on a map in a grid pattern, though claimed subject matter is not so limited. Heatmap or connectivity information may be provided for individual grid points in metadata organized by rows, for example. In one implementation, a single row may include values for RSSI, RSSI variances (e.g., standard deviation or other uncertainty characteristics of RSSI values), RTT, and RTT variances for associated access points. Here, the access points may be represented by their MAC ID addresses, for example. In one particular implementation, an RSSI heatmap value and associated variance may be represented by one byte each while a delay heatmap value (e.g., corresponding to round-trip time measurements) and associated variance may be represented by two bytes each, though claimed subject matter is not limited in this respect. Additionally, a single field may indicate connectivity (i.e., a feasible path) with adjoining grid points (e.g., Boolean 1 or 0 to indicate whether there is connectivity with an associated grid point). Accordingly, heatmap data indicating expected RSSI or RTT values associated with access points may enable an MS to associate signal measurements with locations in an indoor area. By matching measured RSSI or RTT values of acquired signals marked with particular MAC IDs with expected RSSI or RTT values for signals marked by these particular MAC IDs at a specific location, the location of the MS may be inferred to be at the specific location.

In one implementation, an MS may determine RTT values by transmitting a probe signal and measuring an elapsed time until the MS receives an acknowledging response from one or more access points. For example, an MS may identify individual access points using a MAC ID of the individual access points. An MS may infer its distance to a particular access point based, at least in part, on an RTT value comprising the elapsed time between probe signal transmission and a probe signal response from the particular access point. Such an elapsed time may comprise travel time of the probe signal and the probe signal response in addition to a process delay at the access point. For example, such a process delay may include a time that it takes for an access point to receive a probe signal and to process and transmit a probe response signal. In some cases, RTT values may be affected by multi-path signals, wherein an MS may receive a probe response signal from an access point via more than one path. In such a case, different RTT values may arise for different signal paths. In one implementation, the shortest signal path (e.g., the smallest RTT value) or the strongest (e.g., highest signal amplitude) received probe signal may be considered to be associated with a line-of-sight path, which an MS may use to infer distance to an access point.

A radio heatmap model, such as that described above, for example, may be based, at least in part, on measured RSSI or RTT values of an acquired signal that are determined, at least in part, by a range from a receiver to a transmitter. In one particular implementation, it may be recognized that measured RSSI or RTT values of an acquired signal may be affected by factors other than a range from a receiver to a transmitter. In one example, a measured RSSI or RTT value may also be affected by a “context” of an MS or a user co-located with the MS. Examples of different contexts may include, for example, an MS being held in a user's hand while the user is walking, an MS in a user's front shirt pocket, an MS in a purse or handbag, an MS in a holster, an MS with an attached battery pack, or whether a user is sitting with an MS in a cubicle environment, just to provide a few examples. In one example, a particular context of an MS may affect RTT values by affecting whether or not, and to what extent probe signals or probe response signals travel via multiple paths (e.g., multi-path). In another example, probe response signals may travel through different materials for different contexts of an MS. Accordingly, probe response signals may be attenuated differently for the different materials.

Different contexts associated with an MS may be detected by, for example, processing signals received from one or more sensors on the MS. Such sensors may comprise, for example, ambient light sensors, inertial sensors (e.g., accelerometers, gyroscopes, magnetometers), temperature sensors, or a microphone, just to name a few examples. Alternatively, different contexts may be determined other than at an MS, such as at a land-based server, for example. In such a case, information regarding contexts may be wirelessly provided to an MS. In one example, context-related information provided to a server and matched in a point-of-interest database may allow for determining the context of “shopping in aisle”. Such context information may then be provided to an MS. In another example, if a person is using a computer at the person's desk, such computer use may allow for a determination of a context of “sitting at desk”. Such context information may then be provided to an MS.

Various techniques are described herein which may be implemented in one or more land-based computing platforms or an MS to affect or alter an application of a radio heatmap, which may comprise a particular example of a representation of a signal environment in which the wireless signals were acquired, to determining a position fix for an MS. In one example implementation, application of a radio heatmap for obtaining a position fix for an MS may be affected or altered based, at least in part, on a classified or determined context of the MS (or of a user in possession of the MS). Also, wireless signal fingerprints may also be affected or altered based, at least in part, on a classified or determined context of the MS. Here, wireless signal fingerprints may be used in a process of recording ground truths, providing an MS of its location, or storing wireless signals transmitted by one or more wireless beacon devices. Such a process performed at multiple locations in a building, for example, may be called “fingerprinting a building”. Once such fingerprints are collected, a newly-introduced MS may determine its most likely location by comparing what signals it receives to a fingerprint database. Those of skill in the art will appreciate that techniques described herein may be implemented to affect or alter an application of a representation of a signal environment other than a heatmap or fingerprint. Thus, while the description herein may refer to a heatmap and/or a fingerprint, embodiments are not limited to those representations.

RSSI or RTT values of an acquired transmission signal may comprise parameters that correspond to signal loss and may indicate a distance traveled by the transmission signal. For example, RTT may increase as the travel distance of a signal increases. In another example, RSSI may decrease as the travel distance of a signal increases. In some cases, one or more propagation parameters may be used to predict or infer, at least in part, signal loss over distance. Such signal loss, for example, may comprise exponential or linear signal degradation, though claimed subject matter is not so limited.

A radio heatmap may comprise a collection of heatmap values corresponding to expected RSSI or RTT values at particular locations (e.g., grid points) represented by the radio heatmap. For example, a radio heatmap may comprise heatmap values individually corresponding to particular grid points or relatively small areas of a region represented by a map of the region. Such a map may comprise a plurality of electronic signals representative of physical locations of a region and expected RSSI or RTT values for the physical locations. In a particular example, an RSSI heatmap of a shopping mall or office building may comprise a map of the shopping mall or office building including expected RSSI measurements for various locations (e.g., grid points) of the shopping mall or office building.

In some implementations, an MS may receive navigation assistance data from a navigation system (e.g., located at a land-based server) as the MS enters a particular area. Such navigation assistance data may comprise a digital electronic map, for example. A navigation system may comprise an indoor navigation application, which may include one or more maps to show features of indoor structures such as doors, hallways, entry ways, walls, or points of interest (e.g., bathrooms, pay phones, room names, stores). Navigation assistance data may further include, for example, a radio heatmap to facilitate measurements of ranges to wireless access points positioned at known fixed locations. As mentioned above, a radio heatmap may comprise information indicating, for a location on a map, expected RSSI or RTT values associated with particular access points among a plurality of access points. Accordingly, by obtaining a digital electronic map, and by determining a current location by measuring RSSI or RTT values and using a radio heatmap, an MS may digitally overlay the current location of the MS on the map, for example. A digital electronic map or a radio heatmap may be stored at a server to be accessible by an MS through selection of a URL, for example.

In an implementation, measurements of at least one characteristic of one or more wireless signals acquired at an MS may be obtained and used in a process of obtaining a position fix of an MS. For example, a measurement of one or more characteristics of wireless signals received at an MS may comprise RSSI values, as described above. In one application, a context of a user co-located with the MS or a context of the MS may be determined or classified. For example, a context of a user may comprise a state of sitting or walking. In one case, an MS co-located with a sitting user may measure an RSSI value based, at least in part, on received probe response signals that travel through cubicle partitions. In such a case, such probe response signals may be additionally attenuated compared to probe response signals received by an MS co-located with a standing user. Accordingly, all other things being equal, a measured RSSI value may be lower for a “sitting” context compared to a “standing” context. In the case of cubicles, for example, sitting may introduce additional signal attenuation. Thus, to account for a “sitting” context, an expected RSSI value may be reduced. In other words, an MS may use a radio heatmap of RSSI values to determine a location of the MS. However, before such a radio heatmap is used, at least a portion of the radio heatmap may be altered or modified based, at least in part, on the context of the user or the MS co-located with the user. An existing heatmap need not be modified in all embodiments; for example, a new heatmap may be calculated using additional data (e.g., using not just information regarding a building's walls, but also using cubicle walls or other stanchions if a user is seated). For example, at a particular location and for a particular access point associated with a MAC ID, a radio heatmap may indicate an expected value for RSSI at the particular location. Such an expected value may be reduced, however, if an MS receiving the RSSI is in a pocket of a user, as opposed to being held in the user's hand. In addition to affecting RSSI values, different contexts may also affect variance or standard deviation of RSSI values, RTT values, and variance or standard deviation of RTT values, for example. RTT measurements may be affected by attenuation. For example, access points may use an observed RSSI to trigger changes in signal transmission characteristics (e.g., timing, signal strength). This may generate undesirable multiple peaks in a probe response, so that time of arrival of particular signals may be relatively difficult to determine. For example, if an MS is in a relatively poor signal state (e.g., by being in a carrying bag), the MS may activate different algorithms to detect or mitigate different types of signaling from an access point.

In a particular implementation, a context of a user or MS may determine a rate at which at least one characteristic of one or more wireless signals may be measured. For example, RSSI may be measured relatively often if the context of a user comprises “walking”, whereas RSSI may be measured less often if the context of a user comprises “sitting”. Changing a frequency of measuring at least one characteristic of one or more wireless signals based, at least in part, on context may provide a number of advantages. For example, an MS may change position at a relatively slow rate for a “sitting” context. In this case, a relatively low rate of RSSI measurements may be sufficient to obtain a position fix of the MS. Accordingly, battery life of the MS may be extended by reducing a rate of RSSI measurements. On the other hand, an MS may change position at a relatively fast rate for a “walking” or “running” context. In this case, a relatively high rate of RSSI measurements may be desirable to obtain a position fix of the MS. Accordingly, an MS may increase a rate of RSSI measurements to improve an estimate of an MS location. A context of a user may also affect particle filter operation such as by changing an operation of a particle filter by changing a quantity of new particles or a velocity of particle propagation, for example.

In another particular implementation, affecting application of a radio heatmap to RSSI measurements for obtaining a position fix of an MS may be based, at least in part, on one or more behaviors of a user co-located with the MS. For example, whether a user occupies a particular room several days per week during a lunch hour may be considered while determining how to apply a radio heatmap to RSSI measurements. In one implementation, a memory device may store time-stamped position fixes to maintain a record of where a user may have been located at different times. An application may be executed by a processor, for example, to use such time-stamped location information to search for behavioral patterns of a user that may indicate or predict a context for the user.

In an implementation, a technique for detecting a context of an MS or of a user in possession of the MS may involve processing sensor measurements from one or more sensors included in the MS. Sensors may comprise any of a number of sensor types, such as inertial sensors (e.g., accelerometers, gyroscopes, magnetometers, etc.) and environment sensors (e.g., temperature sensors, microphones, barometric pressure sensors, ambient light sensors, camera imager, etc.), as discussed above. Such sensors may be used to estimate a location or motion state of the MS. A lookup table stored in the MS may be used for adjusting expected signal characteristics based, at least in part, on a determined context of the MS. Such a Table may include empirical data corresponding to a plurality of context classifications, as explained below.

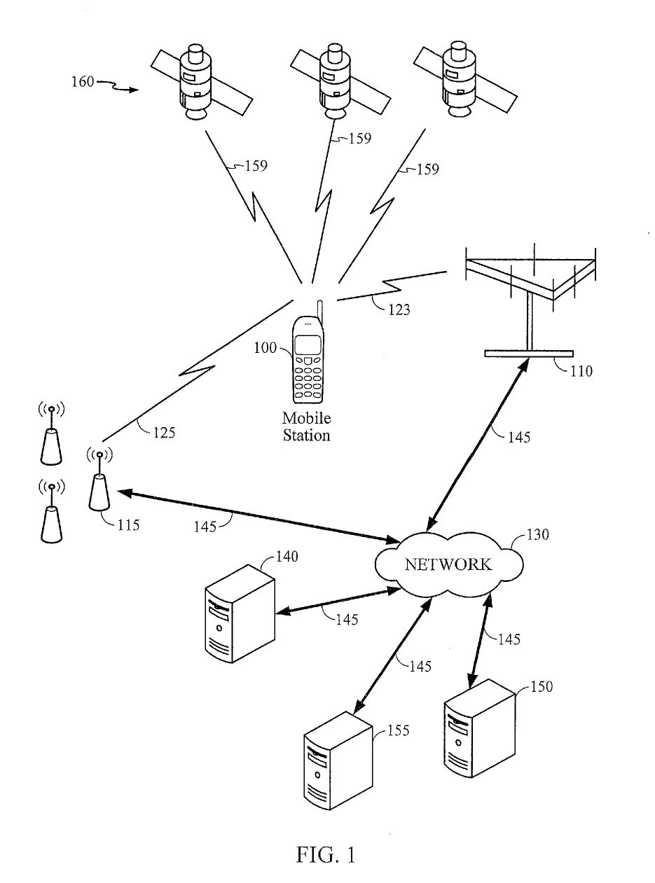

In certain implementations, as shown in FIG. 1, an MS 100 may receive or acquire SPS signals 159 from SPS satellites 160. In some embodiments, SPS satellites 160 may be from one global navigation satellite system (GNSS), such as the GPS or Galileo satellite systems. In other embodiments, the SPS Satellites may be from multiple GNSS such as, but not limited to, GPS, Galileo, Glonass, or Beidou (Compass) satellite systems. In other embodiments, SPS satellites may be from any one several regional navigation satellite systems (RNSS') such as, for example, WAAS, EGNOS, QZSS, just to name a few examples.

In addition, the MS 100 may transmit radio signals to, and receive radio signals from, a wireless communication network. In one example, MS 100 may communicate with a cellular communication network by transmitting wireless signals to, or receiving wireless signals from, a base station transceiver 110 over a wireless communication link 123. Similarly, MS 100 may transmit wireless signals to, or receiving wireless signals from local transceivers 115 over a wireless communication link 125. In a particular implementation, one or more local transceivers 115 may be configured to communicate with MS 100 at a shorter range over wireless communication link 123 than at a range enabled by base station transceiver 110 over wireless communication link 123. For example, local transceivers 115 may be positioned in an indoor environment. Local transceivers 115 may provide access to a wireless local area network (WLAN, e.g., IEEE Std. 802.11 network) or wireless personal area network (WPAN, e.g., Bluetooth network). In another example implementation, local transceivers 115 may comprise a femto cell transceiver capable of facilitating communication on link 125 according to a cellular communication protocol. Of course, it should be understood that these are merely examples of networks that may communicate with an MS over a wireless link, and claimed subject matter is not limited in this respect.

In a particular implementation, base station transceiver 110 and local transceivers 115 may communicate with servers 140, 150 and 155 over a network 130 through links 145. Here, network 130 may comprise any combination of wired or wireless links. In a particular implementation, network 130 may comprise Internet Protocol (IP) infrastructure capable of facilitating communication between MS 100 and servers 140, 150 or 155 through local transceivers 115 or base station transceiver 110. In another implementation, network 130 may comprising cellular communication network infrastructure such as, for example, a base station controller or master switching center to facilitate mobile cellular communication with MS 100.

In particular implementations, and as discussed below, MS 100 may have circuitry and processing resources capable of computing a position fix or estimated location of MS 100. For example, MS 100 may compute a position fix based, at least in part, on pseudorange measurements to four or more SPS satellites 160. Here, MS 100 may compute such pseudorange measurements based, at least in part, on pseudonoise code phase detections in signals 159 acquired from four or more SPS satellites 160. In particular implementations, MS 100 may receive from server 140, 150 or 155 positioning assistance data to aid in the acquisition of signals 159 transmitted by SPS satellites 160 including, for example, almanac, ephemeris data, Doppler search windows, just to name a few examples.

In other implementations, MS 100 may obtain a position fix by processing signals received from terrestrial transmitters fixed at known locations (e.g., such as base station transceiver 110) using any one of several techniques such as, for example, advanced forward trilateration (AFLT) and/or observed time difference of arrival (OTDOA). In these particular techniques, a range from MS 100 may be measured to three or more of such terrestrial transmitters fixed at known locations based, at least in part, on pilot signals transmitted by the transmitters fixed at known locations and received at MS 100. Here, servers 140, 150 or 155 may be capable of providing positioning assistance data to MS 100 including, for example, locations and identities of terrestrial transmitters to facilitate positioning techniques such as AFLT and OTDOA. For example, servers 140, 150 or 155 may include a base station almanac (BSA) which indicates locations and identities of cellular base stations in a particular region or regions.

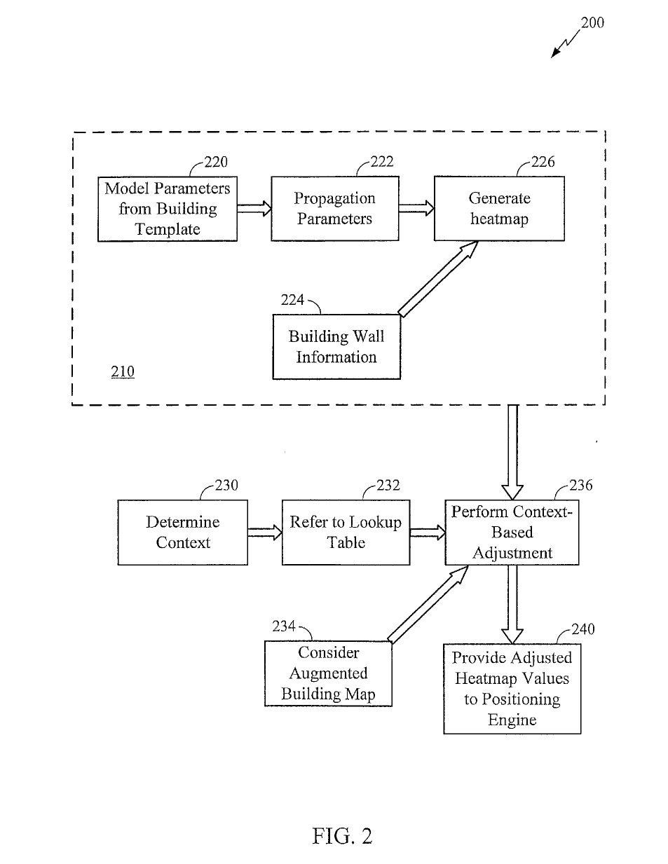

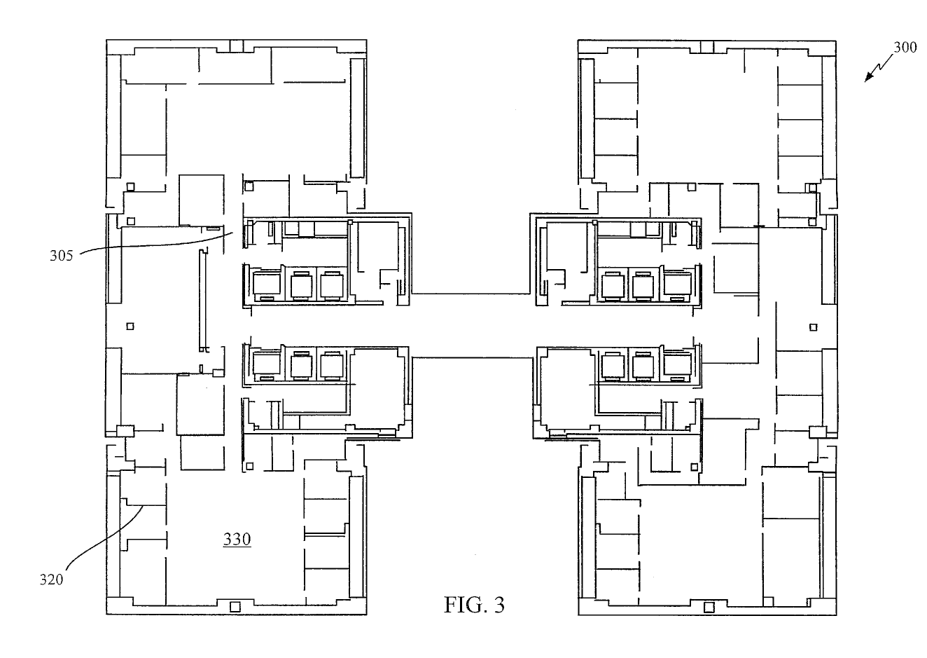

In particular environments such as indoor environments or urban canyons, MS 100 may not be capable of acquiring signals 159 from a sufficient number of SPS satellites 160 or perform AFLT or OTDOA to compute a position fix. Alternatively, MS 100 may be capable of computing a position fix based, at least in part, on signals acquired from local transmitters (e.g., femto cells or WLAN access points positioned at known locations), such as access point 310 shown in FIG. 3. For example, MSs may obtain a position fix by measuring ranges to three or more indoor terrestrial wireless access points which are positioned at known locations, as shown in FIG. 2. Such ranges may be measured, for example, by obtaining a MAC ID address from signals received from such access points and obtaining range measurements to the access points by measuring one or more characteristics of signals received from such access points such as, for example, received signal strength (RSSI) or round trip time (RTT). In alternative implementations, MS 100 may obtain an indoor position fix by applying characteristics of acquired signals to a radio heatmap indicating expected RSSI or RTT values at particular locations in an indoor area.

In particular implementations, MS 100 may receive positioning assistance data for indoor positioning operations from servers 140, 150 or 155. For example, such positioning assistance data may include locations and identities of transmitters positioned at known locations to enable measuring ranges to these transmitters based, at least in part, on a measured RSSI and/or RTT, for example. Other positioning assistance data to aid indoor positioning operations may include radio heatmaps, locations and identities of transmitters, routeability graphs, just to name a few examples. Other assistance data received by the MS may include, for example, local maps of indoor areas for display or to aid in navigation. Such a map may be provided to MS 100 as MS 100 enters a particular indoor area. Such a map may show indoor features such as doors, hallways, entry ways, walls, etc., points of interest such as bathrooms, pay phones, room names, stores, etc. By obtaining and displaying such a map, an MS may overlay a current location of the MS (and user) over the displayed map.

In one implementation, a routeability graph and/or digital map may assist MS 100 in defining feasible areas for navigation within an indoor area and subject to physical obstructions (e.g., walls) and passage ways (e.g., doorways in walls). Here, by defining feasible areas for navigation, MS 100 may apply constraints to aid in the application of filtering measurements for estimating locations and/or motion trajectories according to a motion model (e.g., according to a particle filter and/or Kalman filter). In addition to measurements obtained from the acquisition of signals from local transmitters, according to a particular embodiment, MS 100 may further apply a motion model to measurements or inferences obtained from inertial sensors (e.g., accelerometers, gyroscopes, magnetometers, etc.) and/or environment sensors (e.g., temperature sensors, microphones, barometric pressure sensors, ambient light sensors, camera imager, etc.) in estimating a location or motion state of MS 100.

According to an embodiment, MS 100 may access indoor navigation assistance data through servers 140, 150 or 155 by, for example, requesting the indoor assistance data through selection of a universal resource locator (URL). In particular implementations, servers 140, 150 or 155 may be capable of providing indoor navigation assistance data to cover many different indoor areas including, for example, floors of buildings, wings of hospitals, terminals at an airport, portions of a university campus, areas of a large shopping mall, just to name a few examples. Also, memory resources at MS 100 and data transmission resources may make receipt of indoor navigation assistance data for all areas served by servers 140, 150 or 155 impractical or infeasible, a request for indoor navigation assistance data from MS 100 may indicate a rough or course estimate of a location of MS 100. MS 100 may then be provided indoor navigation assistance data covering areas including and/or proximate to the rough or course estimate of the location of MS 100.

In one particular implementation, a request for indoor navigation assistance data from MS 100 may specify a location context identifier (LCI). Such an LCI may be associated with a locally defined area such as, for example, a particular floor of a building or other indoor area which is not mapped according to a global coordinate system. In one example server architecture, upon entry of an area, MS 100 may request a first server, such as server 140, to provide one or more LCIs covering the area or adjacent areas. Here, the request from the MS 100 may include a rough location of MS 100 such that the requested server may associate the rough location with areas covered by known LCIs, and then transmit those LCIs to MS 100. MS 100 may then use the received LCIs in subsequent messages with a different server, such as server 150, for obtaining navigation assistance relevant to an area identifiable by one or more of the LCIs as discussed above (e.g., digital maps, locations and identifies of beacon transmitters, radio heatmaps or routeability graphs).

FIG. 2 is a schematic block diagram of a process 200 to generate a radio heatmap and to determine a position of an MS, according to an implementation. In process 200, an application of a radio heatmap to RSSI measurements received at an MS for obtaining a position fix may be affected based, at least in part, on a classified context of the MS or a user co-located with the MS. Process 200 may comprise a process portion 210 that may be performed by the MS or another entity, such as servers 140, 150 or 155 shown in FIG. 1, for example. Further, process portion 210 may be performed “off-line” during a time prior to a process of determining a position fix for an MS. For example, as explained in detail below, actions corresponding to blocks 220, 222, 224, and 226 may be performed independently of blocks 230, 232, 234, 236, and 240, though claimed subject matter is not so limited.

Process portion 210 may include block 220, where model parameters may be based, at least in part, on a general structure of a building. Model parameters, may comprise dimensions or sizes or building features, such as entryways, hallways, rooms, or a floor plan, just to name a few examples. Propagation parameters corresponding to block 222 and the model parameters of a building may be used to generate values of a radio heatmap for the building at block 226. Here, such propagation parameters may be used to predict or infer, at least in part, signal loss over distance though air, walls, or other building materials, for example. Such signal loss may comprise exponential or linear signal degradation, though claimed subject matter is not so limited. Corresponding to block 224, wall characterization of the building may also be used to generate values of a radio heatmap at block 226. For example, such wall characterization may comprise a mapping of layout or locations of walls or partitions that at least partially separate rooms or hallways from one another. In one implementation, descriptions of cubicle partitions that separate cubicle spaces need not be included in such wall information since cubicle partitions may be considered in a separate process, as explained below.

At block 230, a context of an MS or a user co-located with the MS may be determined or classified. Some examples of context of a user co-located with an MS include a user sitting, standing, walking, holding the MS in a pocket or bag, storing the MS in a carry case, located in an open area of a floor space, located in a cubicle area and standing, located in a cubicle area and sitting, and so on. A context may be determined or classified based, at least in part, on sensor measurements from one or more sensors of the MS to estimate a location or motion state of an MS or a user co-located with the MS. For example, sensors may comprise inertial or position sensors, such as, an accelerometer, a gyroscope, a magnetometer, a compass, a gravitometer, and so on. Sensors may also comprise environment sensors, such as a temperature sensor, an audio sensor, a proximity sensor, a microphone, a barometric pressure sensor, an ambient light sensor, a camera imager, and so on. Some examples of techniques that may be used to estimate a location or motion state of an MS or a user co-located with the MS using sensor measurements are described as follows. For a first example, inertial or position sensor measurements may be used to determine an orientation or location of an MS. Some examples may include being in a pocket or carry case, resting on a desktop, being held upright in a user's hand, being in motion, and so on. For example, combined with other measurements, an MS oriented on its side may indicate that the MS is resting on a table or desk if the MS is not in motion. In another example, environment sensor measurements may be used to determine a location of an MS. Combined with other measurements, an MS in a location characterized by relatively low ambient sound volume (e.g., as measured by a microphone) may indicate that the MS is in a cubicle area as opposed to being in a reception area. Of course, such details of sensor applications are merely examples, and claimed subject matter is not so limited.

In one implementation, a context of an MS or a user co-located with the MS may be classified based, at least in part, on an elapsed time that a user or an MS is in a particular location or motion state. For example, if a motion state of a user comprises non-movement for more than several minutes, it may be determined that the user is sitting as opposed to standing. In one particular implementation, a determination may be made as to whether a user is sitting in an open area or a cubicle area.

At block 232, in one implementation, sensor measurements may be compared to values in a lookup table stored in an MS to classify a context of the MS or a user co-located with the MS. Classifying a context may be based, at least in part, on sensor measurements, as described above. For example, a lookup table may comprise values based, at least in part, on empirical data comprising sensor measurements. A lookup table may correlate such empirical data with corresponding context classifications. For example, referring to a lookup table, one particular range of sensor measurements may indicate that a context of an MS is “sitting”, while another particular range of sensor measurements may indicate that a context of the MS is “standing”.

In another implementation, a lookup table may used in a process to adjust heatmap values based, at least in part, on a classified context. For example, process 200 may include block 236 where a context-based adjustment of heatmap values from block 226 may be performed. For example, as indicated above, such heatmap values may have been generated at an earlier time (e.g., off-line) based, at least in part, on building parameters (e.g., block 220) and propagation parameters (e.g., block 222). A context, as determined at block 230, may be used with a lookup table to determine how to adjust signal characteristics. In one example, such a lookup table may be used to determine by how much a quantity of RSSI is to be added or subtracted to or from an expected RSSI value based, at least in part, on context of an MS. For another example, if a context of an MS is “sitting”, then a lookup table may indicate that 7.0 dB is to be subtracted from an expected signal characteristic of the heatmap provided from process portion 210. In another example, if a context of an MS is “located in a pocket”, then a lookup table may indicate that 4.0 dB is to be subtracted from an expected signal characteristic of the heatmap. Of course, such details of a lookup table are merely examples, and claimed subject matter is not so limited.

In one implementation, a building template or map, as introduced at block 220, used to generate a heatmap (e.g., block 226) may be augmented with additional building map information, as at block 234. For example, if the context of a user comprises “sitting”, then a map of a building may be augmented with descriptions (e.g., locations or dimensions) of cubicle partitions that separate cubicle spaces in the building so as to account for a possibility that the user is located in a cubicle. In such a case, cubicle partitions may decrease RSSI values of a heatmap. Such a decrease may be due, at least in part, to attenuation of signals transmitted by access points. Thus, cubicle partitions, in addition to walls of the building, may be considered in determining expected signal characteristics if a user is sitting in a cubicle, for example. Accordingly, at block 236, heatmap values based, at least in part, on walls of the building may be adjusted to also be based, at least in part, on cubicle partitions, for example.

A heatmap comprising original expected signal characteristics from block 226 and expected signal characteristics adjusted at block 236 may be provided to a positioning engine at block 240. Such a positioning engine may obtain a position fix of an MS by attempting to match heatmap values measured at the MS to the adjusted expected signal characteristics.

FIG. 3 is a map 300 of a floor of a building sans cubicles, according to an implementation. Map 300 may show, among other things, a number of hallways 305 and walls 320. An area 330 may comprise a relatively open area void of walls. In an implementation, a heatmap may be generated based, at least in part, on map 300. For example, at block 226 in process 200, a heatmap may be generated based, at least in part, on a map such as map 300.

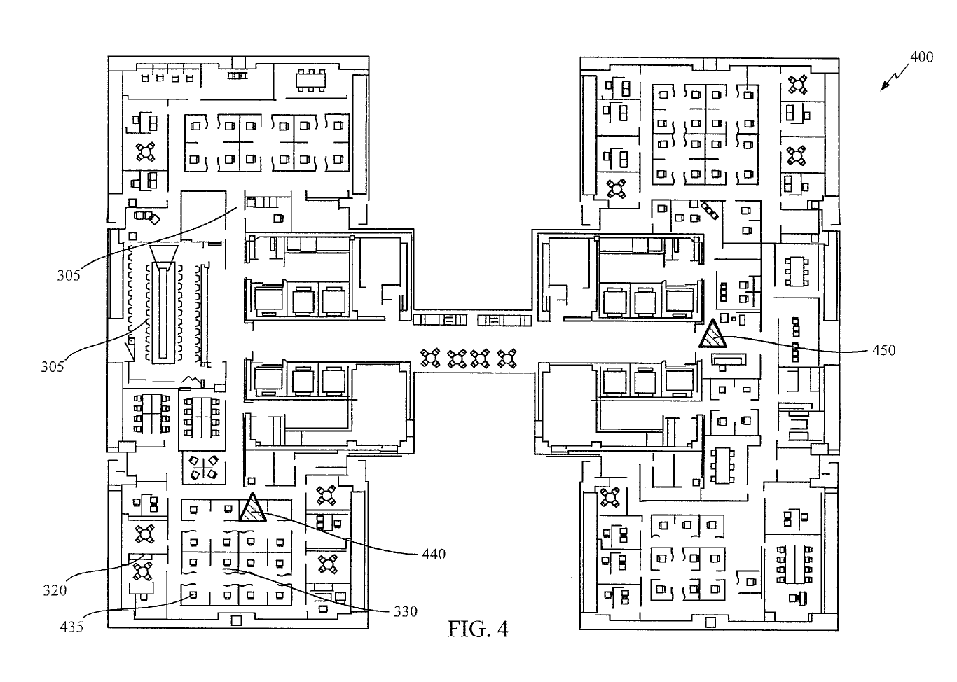

In an implementation, a method for obtaining a position fix of an MS may comprise obtaining measurements of RSSI at an MS, classifying a context of a user co-located with the MS, and affecting application of a heatmap to the RSSI measurements based, at least in part, on the classified context. Such a heatmap may be based, at least in part, on particular map information (e.g., locations of walls, halls, rooms, and so on), as discussed above. Affecting an application of such a heatmap may be further based, at least in part, on additional map information corresponding to a particular context classification of the user. For example, such a particular context classification of a user may comprise a sitting state and such additional map information may comprise locations of cubicle partitions. A particular context classification of a user may further comprise a location of the sitting state. In one implementation, additional map information may be provided by a map that includes information regarding locations of halls, walls, rooms, and cubicles. For example, FIG. 4 is a map 400 of a floor of a building showing cubicles, according to an implementation. Map 400 may be similar to map 300 except that map 400 may include mapping of cubicles. For example, map 400 may show, among other things, a number of hallways 305, walls 320, a conference table 410, and cubicles 435. In map 300, area 330 is shown to comprise a relatively open area. However, in map 400, area 330 is shown to comprise a number of cubicles 435.

In an implementation, a heatmap may be generated based, at least in part, on map 400. In this case, cubicle partitions may be considered while generating such a heatmap. On the other hand, a heatmap generated based, at least in part, on map 300 may not consider cubicle partitions while generating a heatmap. A heatmap based, at least in part, on map 300 may be suitably applied to estimating a location of a user co-located with an MS if the user is standing. However, a heatmap based, at least in part, on map 400 may be suitably applied to estimating a location of a user co-located with an MS if the user is sitting. For example, if a user 440 is sitting in a cubicle (co-located with an MS), a signal transmitted from an AP may be attenuated by cubicle partitions (in addition to walls, etc.) before being received by an MS. This may be because the MS may be relatively near the floor of the building, where cubicle partitions may block a line of sight between an AP transmitting an RSSI signal and the MS. Accordingly, knowledge of cubicle locations and dimensions provided by map 400 may facilitate consideration of RSSI signal attenuation by cubicle partitions for obtaining a position fix of the MS. Thus, RSSI values of a heatmap based, at least in part, on map 300 (sans cubicles) may be adjusted for sitting user 440 by using information provided by map 400 (with cubicles).

On the other hand, if a user 450 is sitting in a relatively open area, as opposed to a cubicle area (such as where user 440 sits), then map 400 may provide cubicle locations and dimensions showing that user 450 is located in a relatively open area. Accordingly, RSSI values of a heatmap based, at least in part, on map 300 (sans cubicles) need not be adjusted for sitting user 450.

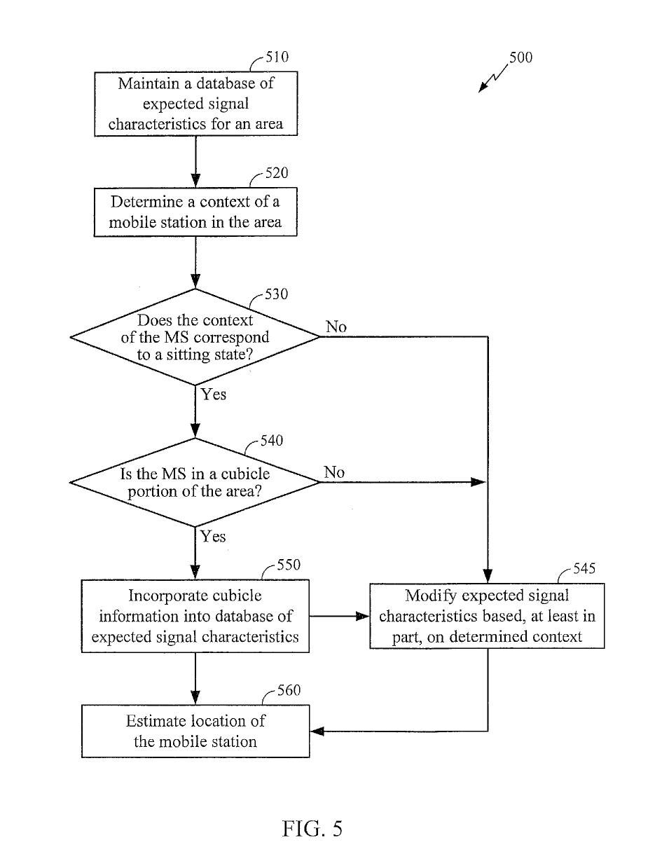

FIG. 5 is a flow diagram illustrating a process 500 for obtaining a position fix of a mobile station, according to an implementation. Process 500 may involve determining whether a user of an MS is sitting in or near a cubicle. If a user is located in or near a cubicle, expected RSSI values of a heatmap may be decreased to account for signals from access points being attenuated by cubicle partitions. In such a case, a database of heatmap values based, at least in part, on walls of a building may be adjusted to also be based, at least in part, on cubicle partitions, for example. Process 500 may be performed by an MS, such as MS 100, or a server, such as 140, shown in FIG. 1, for example. At block 510, an MS or a server, for example, may maintain a database of expected signal characteristics for an area. In an implementation, such a database may comprise a heatmap of expected RSSI values for an area such as an office building or shopping mall, just to name a few examples. Such a database may have been generated at an earlier time, based, at least in part, on a map of walls, rooms, partitions, or hallways of the area.

At block 520, a context of an MS or a user co-located with the MS may be determined. As mentioned above, examples of different contexts may include, for example, an MS being held in a user's hand while the user is walking, an MS in a user's front shirt pocket, an MS in a purse or handbag, or whether a user is sitting with an MS in a cubicle environment, just to provide a few examples. Different contexts associated with an MS may be detected by, for example, processing signals received from one or more sensors on the MS. Such sensors may comprise, for example, ambient light sensors, inertial sensors, temperature sensors, or a microphone, just to name a few examples.

At diamond 530, a determination may be made as to whether the determined context of the MS (or the context of a user co-located with the MS) corresponds to a user co-located with the MS in a “sitting” state. In other words, with respect to the context of the MS, it may be determined whether or not the user is sitting. If not, then process 500 may proceed to block 545, where an expected signal characteristic, such as an expected RSSI value, may be changed or modified based, at least in part, on the context of the MS determined at block 520. Process 500 may then proceed to block 560, where a location of the MS may be estimated based, at least in part, on the database of expected signal characteristics and on one or more modified values of the database, as modified at block 545, for example.

On the other hand, if it is determined that the user is sitting, then process 500 may proceed to diamond 540, where a determination may be made as to whether the MS (or the user co-located with the MS) is located in a cubicle portion of the area. If not, then process 500 may proceed to block 545, where an expected signal characteristic, such as an expected RSSI value, may be modified based, at least in part, on the context of the MS determined at block 520. As discussed above, process 500 may then proceed to block 560, where a location of the MS may be estimated. On the other hand, if it is determined that the MS or user is located in a cubicle portion of the area, then process 500 may proceed to block 550, where cubicle information may be incorporated into the database of expected signal characteristics. For example, cubicle information may comprise descriptions (e.g., locations or dimensions) of cubicle partitions that separate cubicle spaces. As discussed above, in a case where a user is located in or among cubicles, RSSI values may be attenuated by cubicle partitions in addition to walls of a building.

Process 500 may then proceed to block 545, where the database of expected signal characteristics for an area may incorporate cubicle information. Accordingly, such expected signal characteristics (e.g., an expected RSSI value) may be modified based, at least in part, on the context of the MS determined at block 520. Process 500 may then proceed to block 560, where a location of the MS may be estimated based, at least in part, on the database of expected signal characteristics and on one or more modified values of the database, as modified at block 545, for example. Of course, such details of process 500 are merely examples, and claimed subject matter is not so limited.

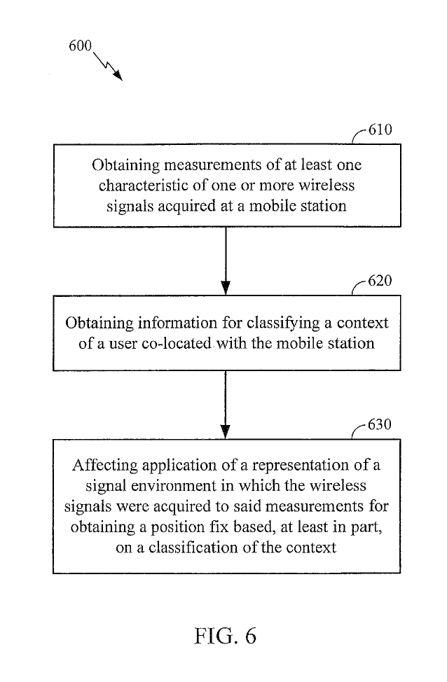

FIG. 6 is a flow diagram illustrating a process 600 for modifying a heatmap, according to an implementation. Process 600 may be performed by an MS, such as MS 100, or a server, such as 140, shown in FIG. 1, for example. At block 610, measurements of at least one characteristic of one or more wireless signals acquired at an MS may be obtained and used in a process of obtaining a position fix of an MS. For example, a measurement of one or more characteristics of wireless signals received at an MS may comprise RSSI values. At block 620, a context of a user co-located with the MS or a context of the MS may be determined or classified. For example, a context of a user may a state of sitting or walking. In one implementation, block 620 may be performed on-the-fly, wherein a context of a user may be classified during a process of obtaining a position of the MS. At block 630, an application of a heatmap to the measurements to obtain a position fix may be affected based, at least in part, on the classified context. For example, an MS may apply a heatmap to measured RSSI to determine its location. However, before such a heatmap is applied, the heatmap may be altered or modified based, at least in part, on the context of the user or on the context of the MS co-located with the user. For example, at a particular location, a heatmap may indicate an expected value for RSSI at the particular location. Such an expected value may be reduced, however, if an MS receiving the RSSI is in a pocket of a user, as opposed to being held in the user's hand. Of course, such details of process 500 are merely examples, and claimed subject matter is not so limited.

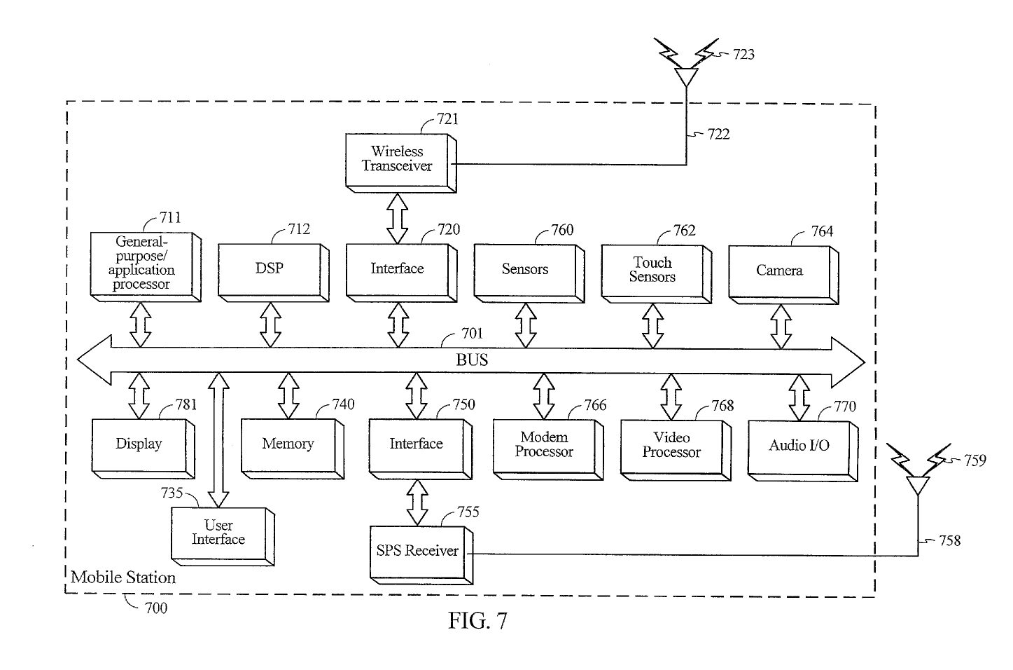

FIG. 7 is a schematic diagram of an MS according to an embodiment. MS 700 may comprise one or more features of MS 100 shown in FIG. 1, for example. In certain embodiments, processes such as 200, 500, or 600, for example, may be implemented using elements included in MS 700. In other embodiments, MS 700 may provide a means for obtaining measurements of at least one characteristic of one or more wireless signals acquired at the mobile station while located in a signal environment; means for obtaining a classification of a context of a user co-located with the mobile station; and means for affecting application of a representation of the signal environment to the measurements for obtaining a position fix based, at least in part, on the classification of the context. In still other embodiments, MS 700 may provide a means for obtaining measurements of at least one characteristic of one or more wireless signals acquired at the mobile station; means for determining a representation of a signal environment in which the wireless signals were acquired based, at least in part, on a detected context of the mobile station; and means for estimating a location of the mobile station based, at least in part, on a match of the obtained measurements with the determined representation. For example, one or more of the means recited above may be implemented by one or more of elements 711, 712, 721, 740, and/or 766, which will now be described in greater detail. For example, MS 700 may comprise a wireless transceiver 721 which is capable of transmitting and receiving wireless signals 723 via an antenna 722 over a wireless communication network, such as over a wireless communication link 123, shown in FIG. 1, for example. Wireless transceiver 721 may be connected to bus 701 by a wireless transceiver bus interface 720. Wireless transceiver bus interface 720 may, in some embodiments be at least partially integrated with wireless transceiver 721. Some embodiments may include multiple wireless transceivers 721 and wireless antennas 722 to enable transmitting and/or receiving signals according to a corresponding multiple wireless communication standards such as, for example, WiFi, CDMA, WCDMA, LTE and Bluetooth, just to name a few examples.

MS 700 may also comprise SPS receiver 755 capable of receiving and acquiring SPS signals 759 via SPS antenna 758. SPS receiver 755 may also process, in whole or in part, acquired SPS signals 759 for estimating a location of MS 1000. In some embodiments, general-purpose processor(s) 711, memory 740, DSP(s) 712 and/or specialized processors (not shown) may also be utilized to process acquired SPS signals, in whole or in part, and/or calculate an estimated location of MS 700, in conjunction with SPS receiver 755. Storage of SPS or other signals for use in performing positioning operations may be performed in memory 740 or registers (not shown).

Also shown in FIG. 7, MS 700 may comprise digital signal processor(s) (DSP(s)) 712 connected to the bus 701 by a bus interface 710, general-purpose processor(s) 711 connected to the bus 701 by a bus interface 710 and memory 740. Bus interface 710 may be integrated with the DSP(s) 712, general-purpose processor(s) 711 and memory 740. In various embodiments, functions or processes, such as processes 200, 500, and 600 shown in FIGS. 2, 5, and 6, for example, may be performed in response to execution of one or more machine-readable instructions stored in memory 740 such as on a computer-readable storage medium, such as RAM, ROM, FLASH, or disc drive, just to name a few example. The one or more instructions may be executable by general-purpose processor(s) 711, specialized processors, or DSP(s) 712.

In one implementation, for example, one or more machine-readable instructions stored in memory 740 may be executable by a processor(s) 711 to perform processes such as process 200, 500, or 600. In another implementation, for example, one or more machine-readable instructions stored in memory 740 may be executable by a processor(s) 711 to: obtain measurements of at least one characteristic of one or more wireless signals acquired at a mobile station while located in a signal environment; obtain a classification of a context of a user co-located with the mobile station; and affect application of a representation of the signal environment to the measurements for obtaining a position fix based, at least in part, on the classification of the context. In another implementation, for example, one or more machine-readable instructions stored in memory 740 may be executable by a processor(s) 711 to: obtain measurements of at least one characteristic of one or more wireless signals acquired at a mobile station; determine a representation of a signal environment in which the one or more wireless signals were acquired based, at least in part, on a detected context of the mobile station; and estimate a location of the mobile station based, at least in part, on a match of the obtained measurements with the determined representation. Memory 740 may comprise a non-transitory processor-readable memory and/or a computer-readable memory that stores software code (programming code, instructions, etc.) that are executable by processor(s) 711 and/or DSP(s) 712 to perform functions described herein.

Also shown in FIG. 7, a user interface 735 may comprise any one of several devices such as, for example, a speaker, microphone, display device, vibration device, keyboard, touch screen, just to name a few examples. In a particular implementation, user interface 735 may enable a user to interact with one or more applications hosted on MS 700. For example, devices of user interface 735 may store analog or digital signals on memory 740 to be further processed by DSP(s) 712 or general purpose processor 711 in response to action from a user. Similarly, applications hosted on MS 700 may store analog or digital signals on memory 740 to present an output signal to a user. In another implementation, MS 700 may optionally include a dedicated audio input/output (I/O) device 770 comprising, for example, a dedicated speaker, microphone, digital to analog circuitry, analog to digital circuitry, amplifiers and/or gain control. It should be understood, however, that this is merely an example of how an audio I/O may be implemented in an MS, and that claimed subject matter is not limited in this respect. In another implementation, MS 700 may comprise touch sensors 762 responsive to touching or pressure on a keyboard or touch screen device.

MS 700 may also comprise a dedicated camera device 764 for capturing still or moving imagery. Camera device 764 may be used as an environmental sensor, for example. Camera device 764 may comprise, for example an imaging sensor (e.g., charge coupled device or CMOS imager), lens, analog to digital circuitry, frame buffers, just to name a few examples. In one implementation, additional processing, conditioning, encoding or compression of signals representing captured images may be performed at general purpose/application processor 711 or DSP(s) 712. Alternatively, a dedicated video processor 768 may perform conditioning, encoding, compression or manipulation of signals representing captured images. Additionally, video processor 768 may decode/decompress stored image data for presentation on a display device 781 on MS 700.

MS 700 may also comprise sensors 760 coupled to bus 701 which may include, for example, inertial sensors and environment sensors that may be used for ground-truth measurements, as described above. Inertial sensors of sensors 760 may comprise, for example accelerometers (e.g., collectively responding to acceleration of MS 700 in three dimensions), one or more gyroscopes or one or more magnetometers (e.g., to support one or more compass applications). Environment sensors of MS 700 may comprise, for example, temperature sensors, barometric pressure sensors, ambient light sensors, camera imagers, and microphones, just to name few examples. Sensors 760 may generate analog or digital signals that may be stored in memory 740 and processed by DPS(s) or general purpose processor 711 in support of one or more applications such as, for example, applications directed to positioning or navigation operations.

In a particular implementation, MS 700 may comprise a dedicated modem processor 766 capable of performing baseband processing of signals received and downconverted at wireless transceiver 721 or SPS receiver 755. Similarly, modem processor 766 may perform baseband processing of signals to be upconverted for transmission by wireless transceiver 721. In alternative implementations, instead of having a dedicated modem processor, baseband processing may be performed by a general purpose processor or DSP (e.g., general purpose/application processor 711 or DSP(s) 712). It should be understood, however, that these are merely examples of structures that may perform baseband processing, and that claimed subject matter is not limited in this respect.

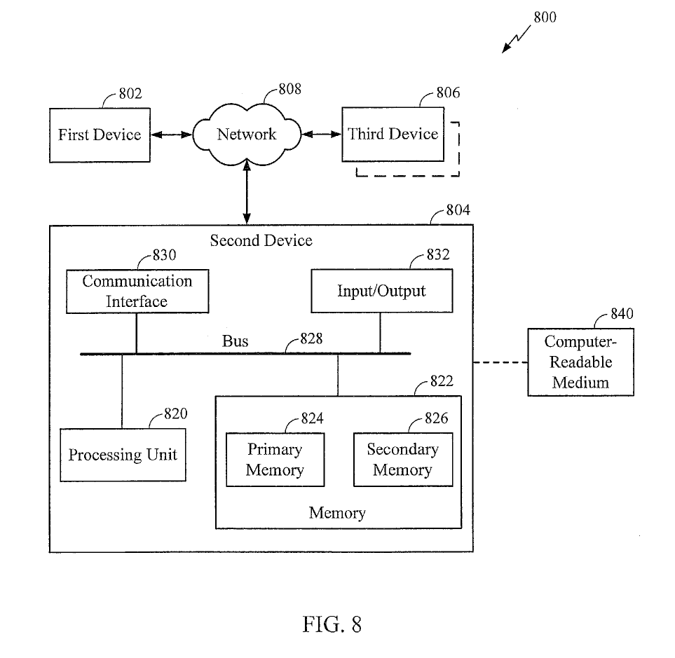

FIG. 8 is a schematic diagram illustrating an example system 800 that may include one or more devices configurable to implement techniques or processes, such as process 800 described above, for example, in connection with FIG. 7. System 800 may include, for example, a first device 802, a second device 804, and a third device 806, which may be operatively coupled together through a wireless communications network 808. In an aspect, first device 802 may comprise a server capable of providing positioning assistance data such as, for example, a base station almanac. First device 802 may also comprise a server capable of providing an LCI to a requesting MS based, at least in part, on a rough estimate of a location of the requesting MS. First device 802 may also comprise a server capable of providing indoor positioning assistance data relevant to a location of an LCI specified in a request from an MS. Second and third devices 804 and 806 may comprise MSs, in an aspect. In one implementation, second device 804 may comprise elements that may be included in a server such as 140, 150, and/or 155. Also, in an aspect, wireless communications network 808 may comprise one or more wireless access points, for example. However, claimed subject matter is not limited in scope in these respects.

First device 802, second device 804 and third device 806, as shown in FIG. 8, may be representative of any device, appliance or machine that may be configurable to exchange data over wireless communications network 808. By way of example but not limitation, any of first device 802, second device 804, or third device 806 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or data storage service provider/system, a network service provider/system, an Internet or intranet service provider/system, a portal or search engine service provider/system, a wireless communication service provider/system; or any combination thereof. Any of the first, second, and third devices 802, 804, and 806, respectively, may comprise one or more of a base station almanac server, a base station, or an MS in accordance with the examples described herein.

Similarly, wireless communications network 808, as shown in FIG. 8, is representative of one or more communication links, processes, or resources configurable to support the exchange of data between at least two of first device 802, second device 804, and third device 806. By way of example but not limitation, wireless communications network 808 may include wireless or wired communication links, telephone or telecommunications systems, data buses or channels, optical fibers, terrestrial or space vehicle resources, local area networks, wide area networks, intranets, the Internet, routers or switches, and the like, or any combination thereof. As illustrated, for example, by the dashed lined box illustrated as being partially obscured of third device 806, there may be additional like devices operatively coupled to wireless communications network 808.

It is recognized that all or part of the various devices and networks shown in system 800, and the processes and methods as further described herein, may be implemented using or otherwise including hardware, firmware, software, or any combination thereof.

Thus, by way of example but not limitation, second device 804 may include at least one processing unit 820 that is operatively coupled to a memory 822 through a bus 828. In one implementation, for example, one or more machine-readable instructions stored in memory 822 may be executable by processing unit 820 to: receive a conceptual map of a navigable area, wherein the conceptual map may include two or more topological elements being related to one another in the conceptual map by a first set of dimensions; apply one or more ground truth measurements or topological constraints to the first set of dimensions of the conceptual map to provide a modified map having corrected dimensions; and map an estimated location of an MS to the modified map.

Processing unit 820 is representative of one or more circuits configurable to perform at least a portion of a data computing procedure or process. By way of example but not limitation, processing unit 820 may include one or more processors, controllers, microprocessors, microcontrollers, application specific integrated circuits, digital signal processors, programmable logic devices, field programmable gate arrays, and the like, or any combination thereof. In certain embodiments, processes such as 200, 500, or 600, for example, may be performed by processing unit 820. In other embodiments, input/output 832 may provide a means for obtaining measurements of at least one characteristic of one or more wireless signals acquired at a mobile station while located in a signal environment. Processing unit 820 may provide a means for obtaining a classification of a context of a user co-located with the mobile station and means for affecting application of a representation of the signal environment to the measurements for obtaining a position fix based, at least in part, on the classification of the context. In still other embodiments, input/output 832 may provide a means for obtaining measurements of at least one characteristic of one or more wireless signals acquired at a mobile station. Processing unit 820 may provide means for determining a representation of a signal environment in which the wireless signals were acquired based, at least in part, on a detected context of the mobile station, and means for estimating a location of the mobile station based, at least in part, on a match of the obtained measurements with the determined representation.

Memory 822 is representative of any data storage mechanism. Memory 822 may include, for example, a primary memory 824 or a secondary memory 826. Primary memory 824 may include, for example, a random access memory, read only memory, etc. While illustrated in this example as being separate from processing unit 820, it should be understood that all or part of primary memory 824 may be provided within or otherwise co-located/coupled with processing unit 820.

Secondary memory 826 may include, for example, the same or similar type of memory as primary memory or one or more data storage devices or systems, such as, for example, a disk drive, an optical disc drive, a tape drive, a solid state memory drive, etc. In certain implementations, secondary memory 826 may be operatively receptive of, or otherwise configurable to couple to, a computer-readable medium 840. Computer-readable medium 840 may include, for example, any non-transitory medium that can carry or make accessible data, code or instructions for one or more of the devices in system 800. Computer-readable medium 840 may also be referred to as a storage medium.

Second device 804 may include, for example, a communication interface 830 that provides for or otherwise supports the operative coupling of second device 804 to at least wireless communications network 808. By way of example but not limitation, communication interface 830 may include a network interface device or card, a modem, a router, a switch, a transceiver, and the like.

Second device 804 may include, for example, an input/output device 832. Input/output device 832 is representative of one or more devices or features that may be configurable to accept or otherwise introduce human or machine inputs, or one or more devices or features that may be configurable to deliver or otherwise provide for human or machine outputs. By way of example but not limitation, input/output device 832 may include an operatively configured display, speaker, keyboard, mouse, trackball, touch screen, data port, etc.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femto cell, utilized to extend cellular telephone service into a business or home. In such an implementation, one or more MSs may communicate with a femto cell via a code division multiple access (“CDMA”) cellular communication protocol, for example, and the femto cell may provide the MS access to a larger cellular telecommunication network by way of another broadband network such as the Internet.

Techniques described herein may be used with an SPS that includes any one of several GNSS and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

What is claimed is:

1. A method comprising:
obtaining measurements of at least one characteristic of one or more wireless signals acquired at a mobile station while located in a signal environment;
obtaining a classification of a context of a user co-located with said mobile station; and
affecting application of a representation of said signal environment to said measurements for obtaining a position fix based, at least in part, on said classification of said context.

2. The method of claim 1, wherein said representation of said signal environment comprises a wireless signal fingerprint.

3. The method of claim 1, wherein said representation of said signal environment comprises a heatmap.

4. The method of claim 3, wherein said at least one characteristic comprises a received signal strength indicator (RSSI), and wherein said affecting said application of said heatmap further comprises:
changing an expected RSSI value for a location, said changing based, at least in part, on the classification; and
attempting to match at least one of said measurements to the changed expected RSSI value.

5. The method of claim 4, wherein said changing said expected RSSI value comprises adding/subtracting a quantity of RSSI to/from said expected RSSI value.

6. The method of claim 3, wherein said heatmap comprises expected RSSI values associated with particular access points.

7. The method of claim 3, wherein said heatmap comprises values for expected received signal strength indicator (RSSI), RSSI variances, round-trip time (RTT), and RTT variances associated with particular MAC IDs associated with access points.

8. The method of claim 1, wherein said obtaining said classification of said context of said user further comprises:
receiving sensor measurements from one or more sensors of said mobile station; and
comparing said sensor measurements to values in a lookup table stored in said mobile station to classify said context of said user.

9. The method of claim 8, wherein said one or more sensors comprise an inertial sensor, a proximity sensor, a temperature sensor, a compass, a gravitometer, or an audio sensor.

10. The method of claim 8, wherein said obtaining said classification of said context of said user is based, at least in part, on elapsed time of a state of said user.

11. The method of claim 10, wherein said state of said user comprises sitting, standing, or moving.

12. The method of claim 8, wherein said values in said lookup table are based, at least in part, on empirical data corresponding to a plurality of context classifications.

13. The method of claim 1, wherein said representation is based, at least in part, on map information, and wherein said affecting said application of said representation is further based, at least in part, on additional map information corresponding to a particular context classification of said user.

14. The method of claim 13, wherein said particular context classification of said user comprises a sitting state and said additional map information comprises cubicle partition locations.

15. The method of claim 14, wherein said particular context classification of said user further comprises a location of said sitting state.

16. The method of claim 1, further comprising:
changing a frequency of measuring said at least one characteristic of said one or more wireless signals based, at least in part, on said context.

17. The method of claim 1, further comprising:
changing an operation of a particle filter based, at least in part, on the classification by changing a quantity of new particles or a velocity of particle propagation.

18. The method of claim 1, wherein said affecting application of said representation of said signal environment is further based, at least in part, on one or more behaviors of said user.

19. The method of claim 1, wherein said obtaining said classification of said context and said affecting application of said representation of said signal environment is performed on-the-fly.

20. The method of claim 1, wherein said method is performed at least partially at said mobile station.

21. The method of claim 1, wherein said method is performed at least partially at a land-based server.

22. An apparatus comprising:
means for obtaining measurements of at least one characteristic of one or more wireless signals acquired at a mobile station while located in a signal environment;
means for obtaining a classification of a context of a user co-located with said mobile station; and
means for affecting application of a representation of said signal environment to said measurements for obtaining a position fix based, at least in part, on said classification of said context.

23. An apparatus comprising:
a transceiver to obtain measurements of at least one characteristic of one or more wireless signals acquired at a mobile station while located in a signal environment; and
one or more processing units to:
obtain a classification of a context of a user co-located with said mobile station; and
affect application of a representation of said signal environment to said measurements for obtaining a position fix based, at least in part, on said classification of said context.

24. The apparatus of claim 23, wherein said representation of said signal environment comprises a wireless signal fingerprint.

25. The apparatus of claim 23, wherein said representation of said signal environment comprises a heatmap.

26. The apparatus of claim 25, wherein said at least one characteristic comprises a received signal strength indicator (RSSI), and wherein said one or more processing units are configured to affect application of said heatmap by:
changing an expected RSSI value for a location, said changing based, at least in part, on the classification; and
attempting to match at least one of said measurements to the changed expected RSSI value.

27. The apparatus of claim 26, wherein said one or more processing units are configured to change said expected RSSI value by adding/subtracting a quantity of RSSI to/from said expected RSSI value.

28. The apparatus of claim 25, wherein said heatmap comprises expected RSSI values associated with particular access points.

29. The apparatus of claim 25, wherein said heatmap comprises values for expected received signal strength indicator (RSSI), RSSI variances, round-trip time (RTT), and RTT variances associated with particular MAC IDs associated with access points.

30. The apparatus of claim 23, wherein said one or more processing units are configured to obtain said classification of said context of said user by:
receiving sensor measurements from one or more sensors of said mobile station; and
comparing said sensor measurements to values in a lookup table stored in said mobile station to classify said context of said user.

31. The apparatus of claim 30, wherein said one or more sensors comprise an inertial sensor, a proximity sensor, a temperature sensor, a compass, a gravitometer, or an audio sensor.

32. The apparatus of claim 30, wherein said one or more processing units are configured to obtain said classification of said context of said user based, at least in part, on elapsed time of a state of said user.

33. The apparatus of claim 32, wherein said state of said user comprises sitting, standing, or moving.

34. The apparatus of claim 30, wherein said values in said lookup table are based, at least in part, on empirical data corresponding to a plurality of context classifications.

35. The apparatus of claim 23, wherein said representation is based, at least in part, on map information, and wherein said one or more processing units are configured to affect said application of said representation based, at least in part, on additional map information corresponding to a particular context classification of said user.

36. The apparatus of claim 35, wherein said particular context classification of said user comprises a sitting state and said additional map information comprises cubicle partition locations.

37. The apparatus of claim 36, wherein said particular context classification of said user further comprises a location of said sitting state.

38. The apparatus of claim 23, wherein said one or more processing units are configured to:
change a frequency of measuring said at least one characteristic of said one or more wireless signals based, at least in part, on said context.

39. The apparatus of claim 23, wherein said one or more processing units are configured to:
change an operation of a particle filter based, at least in part, on the classification by changing a quantity of new particles or a velocity of particle propagation.

40. The apparatus of claim 23, wherein said one or more processing units are configured to affect application of said representation of said signal environment based, at least in part, on one or more behaviors of said user.

41. The apparatus of claim 23, wherein said one or more processing units are configured to obtain said classification of said context and affect application of said representation of said signal environment on-the-fly.

42. A non-transitory storage medium comprising machine-readable instructions stored thereon that are executable by a special purpose computing device to:
obtain measurements of at least one characteristic of one or more wireless signals acquired at a mobile station while located in a signal environment;
obtain a classification of a context of a user co-located with said mobile station; and
affect application of a representation of said signal environment to said measurements for obtaining a position fix based, at least in part, on said classification of said context.

43. A method comprising:
obtaining measurements of at least one characteristic of one or more wireless signals acquired at a mobile station;
determining a representation of a signal environment in which said one or more wireless signals were acquired based, at least in part, on a detected context of said mobile station; and
estimating a location of the mobile station based, at least in part, on a match of the obtained measurements with the determined representation.

44. The method of claim 43, further comprising:
maintaining a database of expected signal characteristics associated with locations in an area, wherein the determining comprises modifying said database of expected signal characteristics based, at least in part, on said detected context of said mobile station, and wherein the estimating comprises estimating the location of the mobile station based, at least in part, on a match of the obtained measurements with the modified expected signal characteristics.

45. The method of claim 44, wherein said representation of said signal environment is based, at least in part, on a map of said area, and wherein said modifying said database is further based, at least in part, on additional information for said map, said additional information corresponding to a particular context classification of said mobile station.

46. The method of claim 45, wherein said particular context classification of said mobile station comprises a sitting state and said additional information comprises cubicle partition locations in said area, and wherein said particular context classification of said mobile station further comprises a location of said sitting state.

47. The method of claim 43, wherein said representation of said signal environment comprises a heatmap or a wireless signal fingerprint.

48. The method of claim 43, wherein said determining comprises:
selecting one representation of said signal environment among a plurality of stored representations of said signal environment based, at least in part, on said detected context.

49. The method of claim 43, wherein said determining comprises:
calculating said representation of said signal environment based, at least in part, on said detected context.

50. The method of claim 43, wherein said representation of said signal environment comprises a received signal strength indicator (RSSI).

51. The method of claim 43, wherein said detected context of said mobile station comprises a position-and-motion state of said mobile station.

52. The method of claim 43, wherein said detected context of said mobile station is based, at least in part, on sensor measurements from one or more sensors of said mobile station and on values in a lookup table stored in said mobile station.

53. The method of claim 43, wherein said detected context of said mobile station is further based, at least in part, on elapsed time of a state of said mobile station.

54. The method of claim 43, further comprising:
changing a frequency of measuring said at least one characteristic of said one or more wireless signals based, at least in part, on said detected context.

55. An apparatus comprising:
means for obtaining measurements of at least one characteristic of one or more wireless signals acquired at a mobile station;
means for determining a representation of a signal environment in which said one or more wireless signals were acquired based, at least in part, on a detected context of said mobile station; and
means for estimating a location of the mobile station based, at least in part, on a match of the obtained measurements with the determined representation.

56. An apparatus comprising:
a transceiver to obtain measurements of at least one characteristic of one or more wireless signals acquired at a mobile station; and
one or more processing units to:
determine a representation of a signal environment in which said one or more wireless signals were acquired based, at least in part, on a detected context of said mobile station; and
estimate a location of the mobile station based, at least in part, on a match of the obtained measurements with the determined representation.

57. The apparatus of claim 56, wherein said one or more processing units are configured to:
maintain a database of expected signal characteristics associated with locations in an area, determine the representation by modifying said database of expected signal characteristics based, at least in part, on said detected context of said mobile station, and estimate the location by estimating the location of the mobile station based, at least in part, on a match of the obtained measurements with the modified expected signal characteristics.

58. The apparatus of claim 57, wherein said representation of said signal environment is based, at least in part, on a map of said area, and wherein said modifying said database is further based, at least in part, on additional information for said map, said additional information corresponding to a particular context classification of said mobile station.

59. The apparatus of claim 58, wherein said particular context classification of said mobile station comprises a sitting state and said additional information comprises cubicle partition locations in said area.

60. The apparatus of claim 56, wherein said representation of said signal environment comprises a heatmap or a wireless signal fingerprint.

61. The apparatus of claim 56, wherein said one or more processing units are configured to determine said representation by selecting one representation of said signal environment among a plurality of stored representations of said signal environment based, at least in part, on said detected context.

62. The apparatus of claim 56, wherein said one or more processing units are configured to determine said representation by calculating said representation of said signal environment based, at least in part, on said detected context.

63. The apparatus of claim 56, wherein said representation of said signal environment comprises a received signal strength indicator (RSSI).

64. The apparatus of claim 56, wherein said detected context of said mobile station comprises a position-and-motion state of said mobile station.

65. The apparatus of claim 56, wherein said detected context of said mobile station is based, at least in part, on sensor measurements from one or more sensors of said mobile station and on values in a lookup table stored in said mobile station.

66. The apparatus of claim 56, wherein said detected context of said mobile station is further based, at least in part, on elapsed time of a state of said mobile station.

67. The apparatus of claim 56, wherein said one or more processing units are configured to:
change a frequency of measuring said at least one characteristic of said one or more wireless signals based, at least in part, on said detected context.

68. A non-transitory storage medium comprising machine-readable instructions stored thereon that are executable by a special purpose computing device to:
obtain measurements of at least one characteristic of one or more wireless signals acquired at a mobile station;
determine a representation of a signal environment in which said one or more wireless signals were acquired based, at least in part, on a detected context of said mobile station; and
estimate a location of the mobile station based, at least in part, on a match of the obtained measurements with the determined representation.
